(19) United States
(12) Patent Application Publication
(10) Pub. No.: US 2006/0249576 A1
(43) Pub. Date: Nov. 9, 2006

(54) Systems and methods for providing near real-time collection and reporting of data to third parties at remote locations

(76) Inventors: Mark Nakada, Salt Lake City, UT (US); Jon Butler, Salt Lake City, UT (US)

Correspondence Address: KENNETH E. HORTON;KIRTON & MCCONKLE, 60 EAST SOUTH TEMPLE, SUITE 1800, SALTLAKE CITY, UT, 84111, US

(21) Appl. No.: 11/397,292

(22) Filed: Apr. 4, 2006

Related U.S. Application Data
(60) Provisional application No. 60/667,638, filed on Apr. 4, 2005.
(60) Provisional application No. 60/672,427, filed on Apr. 19, 2005.
(60) Provisional application No. 60/672,428, filed on Apr. 19, 2005.

(51) Int. Cl. G06K 5/00

(52) U.S. Cl. 235/382

(57) ABSTRACT

Systems and methods for delivering for collecting and reporting real-time or substantial real-time, data from remotely located devices to third parties. The systems contain a centrally located device where the digital content is stored, a remotely-located device for delivering the digital content to an end-user, and means for transferring the digital content from the central location to the remote location. At the remote location(s), information about the user and/or her activities are collected using any known means. Such information includes demographic data, sales transaction data, survey data, system performance data, conversion tracking information, and the like. This collected information can then be reported to parties on a real-time or substantially real-time basis. The data reported can be then used for various purposes, including customizing the advertising for an individual user or a group of users, to facilitate system administration, statistical marketing analyses, or any other purpose.

### RELATED APPLICATIONS

This application claims priority of U.S. Provisional Applications Nos. 60/667,638, 60/672,427, and 60/672,428, the entire disclosures of which are incorporated herein by reference.

### FIELD

This application relates generally to systems and methods for collecting and reporting of data. In particular, this application relates to systems and methods for collecting and reporting real-time or substantial real-time, data from remotely located devices to third parties.

### BACKGROUND

Many types of information and content are now stored digitally, including books, music, movies, software programs, video games, databases, advertisements, as well as other content. Because such content is stored digitally, it can be transferred easily using many types of electronic networks. See, for example, U.S. Pat. Nos. 5,875,110, 4,412,292, 5,848,398, 6,397,189, 6,381,575, 4,674,055, 5,445,295, 5,734,719, 6,286,029, 6,799,165, 6,655,580, 6,330,490, 6,662,080, 6,535,791, 6,711,464, 5,237,157, 6,654,757, 5,794,217, and 6,748,539, the entire disclosures of which are incorporated herein by reference. Both private and public electronic networks, including the Internet, are frequently used to transfer the digital content.

Often the digital content is transferred electronically so that it can be sold to an end-user who is not located where the digital content is originally stored. The digital content can be sold for a variety of purposes, including education, entertainment, research, or other purposes. The digital content may be sold in any number of technological formats known in the art that permit storage and retrieval of the digital data, including floppy discs, compact discs of several varieties; video discs of several varieties, including digital video discs; magnetic storage devices using a variety of forms and technologies; and solid state devices of several varieties.

Most of digital content sales have been to users of computers that are connected to each other via networks of various types, e.g., the Internet. In such instances, it has become common to gather data about the user and/or her activities. Such data can be used for numerous purposes, including being reported to third parties to be used for various purposes, including advertising or sales.

But users are not always located at such a computer when they desire to purchase the digital content, or they have a computer but it is not connected to a network. Consequently, sales of digital content have begun using devices in remote locations including stand-alone devices (such as kiosks) in retail or other high-traffic areas. The stand-alone devices may be attended or unattended.

In addition to delivering digital content, the devices in remote locations can also be used to advertise to the user, as well as to collect and report data about the user and/or her activities. The ability to collect and report such data, however, has been limited for several reasons. First, the information collected from the remote devices is often limited to credit/debit card verification, inventory reports, and accounting information. Second, the information is often collected and reported to third parties in a slow and cumbersome manner, requiring separate reports for each remote device and limiting the use of the information. Third, remote devices are often limited in the content they provide, inherently limiting the information that can be collected about the user and/or her activities. Fourth, access to the information collected by the remote devices is often restricted to those physically present near the device. Fifth, limited data transmission speeds to/from the remote device and the storage capabilities of the remote devices limit the transmission of the data that has been collected. Finally, the data collected targeted has been limited, in some instances, by the small amount of feedback that has been gathered.

### SUMMARY

Systems and methods for delivering for collecting and reporting real-time or substantial real-time, data from remotely located devices to third parties. The systems contain a centrally located device where the digital content is stored, a remotely-located device for delivering the digital content to an end-user, and means for transferring the digital content from the central location to the remote location. At the remote location(s), information about the user and/or her activities are collected using any known means. Such information includes demographic data, sales transaction data, survey data, system performance data, conversion tracking information, and the like. This collected information can then be reported to parties on a real-time or substantially real-time basis. The data reported can be then used for various purposes, including customizing the advertising for an individual user or a group of users, to facilitate system administration, statistical marketing analyses, or any other purpose.

### DESCRIPTION OF THE DRAWINGS

The following description can be better understood in light of the Figures, in which:

FIG. 1 depicts a block diagram representing an exemplary distributed networking system for delivering digital content;

FIG. 2 illustrates a block diagram representing some of the components in an exemplary kiosk that can be used in delivering digital content;

FIG. 3a contains a graph illustrating download and upload activity between a server and a kiosk for semi-dynamic content;

FIG. 3b contains a graph illustrating conventional download and upload activity between a server and a kiosk for dynamic content;

FIG. 3c contains a graph illustrating conventional download and upload activity between a server and a kiosk for static content;

FIG. 4 illustrates some of the activities that are part of one method for delivering digital content at a remote location; and

FIG. 5 illustrates some methods for reporting information that has been collected at a kiosk.

Together with the following description, the Figures demonstrate and explain the principles of the systems and methods collecting and reporting real-time or substantial real-time, data from remotely-located devices to third parties. In the Figures, the thickness and configuration of components may be exaggerated for clarity. The same reference numerals in different Figures represent the same component.

### DETAILED DESCRIPTION

The following description provides specific details in order to provide a thorough understanding. The skilled artisan, however, would understand that the systems and methods can be practiced without employing these specific details. Indeed, the systems and methods can be practiced by modifying the illustrated system and method and can be used in conjunction with apparatus and techniques conventionally used in the industry. While the invention is described for use with a kiosk as a remote device, it could be used for any purpose, including many types of wireless computing devices, consumer electronic devices, military devices, or others.

The systems can deliver digital content (or content) from a first location to one or more second locations that are optionally remote from the first location. Accordingly, the systems contain a first device in a first location where the digital content is stored, a second device in a second location for delivering the digital content to an end-user, and means for semi-dynamically transferring the digital content from the first location to the second location. The systems can also collect data from the device(s) in the second location(s) and report that data to the device in the first location or to device(s) or locations outside the system.

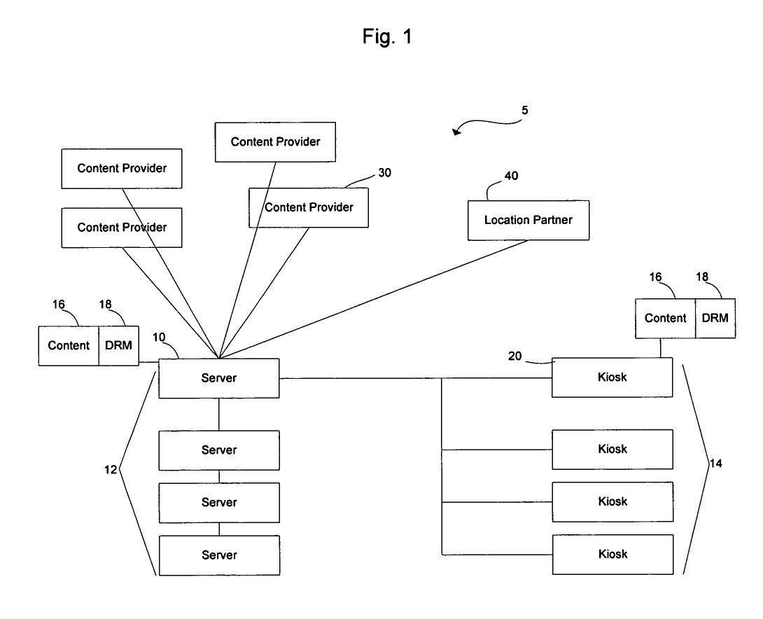

In some aspects, the systems for delivering content are illustrated in FIG. 1. As depicted in that Figure, the system 5 contains a first device (i.e., server 10) located in a first location. The first location can be located anywhere desired by the operator, i.e., in a central location (with central not referring to the geographic location). The first device acts as a repository for the digital content. Any device that can operate as a repository can be used as the first device.

One example of the first device comprises a server 10. Any type of server known in the art can be used as server 10. Examples of servers that can be used include a computer running a UNIX-style operating system, a computer running a Microsoft Windows operating system, or a personal computer workstation. The server 10 comprises any storage component on which the digital content can be stored. Examples of storage components include optical storage discs, DVD-RAM discs, and traditional magnetic hard disc drives.

In some aspects, multiple servers 12 may be connected together to make a server cluster. Using a server cluster permits sharing information regarding the content stored on each server 10 and each transaction the server 10 has recorded. By using a server cluster, the system 5 is always operational, regardless of the location of a particular component on the network that connects the components (such as the Internet). The server cluster can contain a primary cluster, which handles all critical tasks, with minor functions being routed to a secondary cluster. With this configuration, if the primary cluster is not operational, most functions can be handled by the secondary cluster. A server cluster also allows a large-scale deployment and interoperability, as well as data that can be stored on the network in multiple points of co-location.

The software components required for operating the server 10 may be included on a single server or on multiple servers, with each server implementing one or more tasks and communicating among themselves using standard networking protocols. Non-limiting examples of the server-focused tasks using the software components that may be implemented on one or more servers 10 include those of e-mail server; Web server; file server; purchase transaction authentication server; content security server; and advertising message server.

As depicted in FIG. 1, the server 10 contains digital content 16. The types of digital content 16 that can be delivered are virtually unlimited. Examples of the digital content include music, movies, video games, software, mobile phone ring tones, electronic books, advertising, and other types of content. The format in which the digital content is stored is also virtually unlimited. Examples of the types of digital formats include pdf, doc, xls, jpeg, tiff, gif, xbm, pnm, mpeg2, mpeg4, mp3, wma, wmv, mov, wav, and avi, as well as combinations thereof.

The digital content 16 may be provided internally (by the entity that controls or operates the server 10), or externally by one or more third parties that are the copyright owners of the content or that act on behalf of the owners of the content (collectively, content providers 30). Non-limiting examples of content providers 30 include music publishers, recording companies, book publishers, artists, performers, end-users, mobile telephone companies, video game manufacturers, and advertisers. Content providers 30 may provide the content 16 to the server using any known mechanism, including via network connections known in the art or via other methods, such as providing a CD or DVD to the operator of a server 10.

The digital content 16 can include instructions indicating how the content may be used, distributed, sold, transmitted, or otherwise processed (“use instructions”). The server 10 can convert such use instructions into digital rights management (DRM) information 18 that can be associated with any desired content. The DRM information may include any number or combination of restrictions, including those that are enabled by a DRM technology and that are selected by a content provider 30. Non-limiting examples of DRM restrictions include a restriction that visual or textual content not be printed in hardcopy; a restriction that copy-and-paste functions are disabled for textual content; a restriction that a music file may not be played after a certain date; a restriction that a music file or video file may only be played a fixed number of times; and a restriction that a file may only be copied to another device a fixed number of times.

The DRM information may be provided by a third party (such as content provider 30 or location partner 40) or by the operator of a server 10. Either may assign a unique transactional ID to each piece of content 16. This unique transactional ID correlates to a set of use instructions and DRM specifications to control how the associated content is managed on devices, such as on the server 10, as further described hereinafter. The content 16 may therefore contain metatags, use instructions, and a transactional ID.

The content 16 may also contain metatags that correspond to information about any desired content, such as a genre of music or movie, an artist, a content provider, or otherwise. Metatags may be provided by a content provider 30 or created by the operator of a server 10. The metatags may indicate the use instructions for all content that is provided, with distinct use instructions for each piece of content, or with use instructions based on parameters that can be used to classify content. In one example of use instructions, a content provider 30 may indicate that music performed by musical artist A may be redistributed freely, without restriction, music performed by musical artist B may be redistributed freely when purchased at a set price, and music performed by musical artist C may be redistributed in a manner that permits the music to be copied to another computer three times, after which the music may not be copied to another computer, but only played (performed) on a computer where it is stored.

The content 16 may optionally be encrypted in a manner to increase security of the content during storage on a server 10 or on a kiosk 20, or during transfer between a content provider 30 and a server 10, or between a server 10 and a kiosk 20. Any number of encryption methods known to those in the art may be used to implement this feature. Examples of such encryptions include both symmetrical and asymmetrical encryption using a variety of methods, including RSA, DES, Triple DES, Blowfish, ElGamal, RC4, and others.

When the second device is placed in a location that is remote from the first device, a location partner 40 can optionally be used in the system 5 as depicted in FIG. 1. The location partner 40 comprises an individual or entity that provides a space where the second device may be physically located. Non-limiting examples of such location partners include owners or managers of airports, bars, clubs, schools, gyms, stadiums, arenas, amusement parks, military bases, retail centers or shops, and eating establishments.

A location partner 40 may provide this space without charge, as a service to individuals that visit the space where the second device is placed. Or the location partner 40 may provide this space in exchange for a fee of some type, or in exchange for advertising time on the second device, or for other benefits. In some aspects, the location partner 40 may control or limit the content that is available via the second device. In other embodiments, the location partner can also control the advertising.

As described above, the system also contains a second device that can be located in a second location that is optionally remote from the first location. The second device receives the content from the first device and then distributes that content to an end-user. Any device operating in this manner can be used as the second device. In some aspects, the second device comprises a kiosk 20 as depicted in FIG. 1.

Kiosk 20 provides a point-of-sale experience for any user, including both actual and merely potential purchasers of the content and viewers of the advertisement. Any person can be a user by interacting with the kiosk 20, whether purchasing content or merely viewing the kiosk 20 and/or the associated advertising. The kiosk 20 used in the system can be any kiosk known in the art or the kiosk described below. In some embodiments, the kiosk may physically display any known advertising, such as posters, banners, or adhesive advertisements. The kiosk 20 may be used in conjunction with products as a point-of-purchase display.

The kiosk 20 can contain any combination of number of video displays. In some aspects, the kiosk 20 contains two video displays, a first video display that displays advertising messages and a second video display that displays menus, samples of content and related information appropriate to affect a purchase by an end-user of the content made available through the kiosk 20.

The kiosk 20 can also contain multiple input and output devices appropriate to interact with an end-user, display or perform the content stored on the kiosk 20, and complete a sales transaction related to the content. These input and output devices may include, for example, one or more of any of the following: a keyboard; a mouse; a trackball; a joystick; a touchscreen; a LED display; a LCD display; a label maker; an automatic coupon feeder; a barcode scanner; an image scanner; biometric scanning devices such as a fingerprint, voiceprint, hand geometry, or retinal/iris scanner; a Compact Disc reader; a Compact Disc writer; a video disk reader; a video disk writer; and media device connectivity, including a USB port, an IEEE-1394 FireWire port, a SecureDigital (SD) port, a CompactFlash port, a PCMCIA port, a MemoryStick port, a laser printer, a receipt printer, a video camera, a camera, an audio recorder, a credit/debit/gift card reader, a cash acceptor, a coin acceptor, a check acceptor, a jewel case ejector, a phone docking station, speakers, voice recognition device, signature verifier, facial recognition device, Braille input device, bubble sheet/multiple choice form scanner (such as a Scantron machine), Bluetooth communications, Wi-Fi communications, and others known in the art. Furthermore, additional input, output, and storage technologies known in the art may be integrated with the kiosk 20 and the system 5.

The kiosk 20 can also include a controlling device that operates the video displays, interacts with input and output devices, and communicates with other kiosks 20 or servers 10, in real-time or as needed. In some aspects, the controlling device includes two or more computers, either sharing or dedicated to the needed tasks requisite to controlling operation. In some aspects, one computer handles the display, selection, and processing of content purchase transactions and a second computer handles the display of advertising messages.

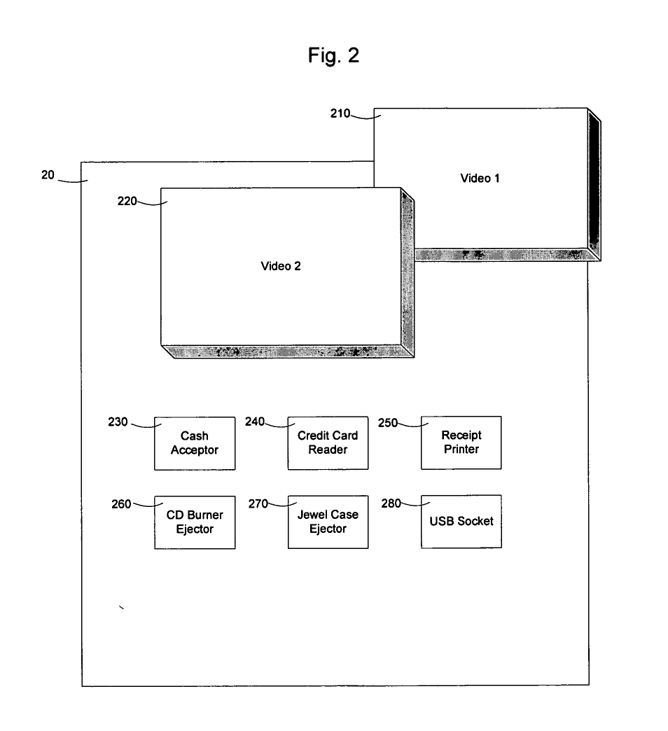

FIG. 2 illustrates one example of kiosk 20. In FIG. 2, kiosk 20 contains a video display 210 on which advertising messages are displayed; a video display 220 comprising a touch screen device through which an end-user may view and select content; a cash acceptor 230 through which an end-user may make payment for content; a credit card reader 240 through which an end-user may make payment for content; a receipt printer 250 that dispenses a paper receipt of a transaction when content is purchased; a CD burner ejector 260 that dispenses an audio CD containing content selected by an end-user during a purchase transaction; a jewel case ejector 270 that dispenses an empty jewel case for holding an audio CD; and a USB socket 280 to which an end-user may connect a device for delivery of content, as described in this specification. As noted previously, a kiosk 20 may contain different—or additional—components that those shown in FIG. 2.

When a user purchases content 16 through a kiosk 20, that content is made available using any delivery device known in the art. Non-limiting examples of delivery devices can include: audio CD, DVD or similar video or data disc, writeable data CD such as WORM or CD-RAM, magnetic and solid state storage devices that communicate with a kiosk 20 via any means known in the art, and hard-copy paper. In some aspects, the content can be placed on a delivery device that can include plug-ins or software that has advertising integrated and can be used to play the content received.

The various components of the system can be electronically connected to each other using any means known in the art. Examples of these connections include Ethernet, frame relay, DSL, satellite uplink, cable modem, analog modem, fibre channel, infrared and microwave transmissions, wireless communications of various types, and other networking technologies known in the art. Such connections may also be constructed through a publicly accessible network, such as the Internet, so long as appropriate security measures, as are known in the art, are used to prevent unauthorized access to the content that passes across the connection. A private network connection may also be used in order to reduce the reliance on such security measures and to further ensure the integrity of content that is transferred via this connection.

The various components of the system are able to communicate with each other whenever needed. In some aspects, server 10 and a kiosk 20 may communicate at regular or scheduled intervals, in real-time, or in an ad hoc manner according to needs that arise as determined by the server 10 or the kiosk 20. Since actual real-time communication may be limited by the transmission speeds available, the communication may be on a substantial or near real-time basis.

In some aspects, the various components of the system need not be electronically connected. For example, the kiosk 20 need not be connected to the server 10 on a continuous basis. Rather, the kiosk operates in a stand-alone mode, with content being transferred to the kiosk 20 via non-networked means, and purchase transactions and demographic data being collected via non-networked, intermittent means. A stand-alone kiosk 20 can be used, for example, when security procedures or network connectivity are not available, such as a kiosk 20 located on a military base in a different country than the server 10 from which it would otherwise receive content.

The systems described above can be used to transfer the digital content from the first device to the second device, where it then can be optionally distributed to an end-user. While the digital content 16 can be transferred by the system in any manner, in some aspects it can be transferred in a semi-dynamic manner. Semi-dynamic transfers occur when, for example, server 10 downloads content to the storage media located at a kiosk 20 at regular intervals (sometimes referred to as “scheduled push times”). The content 16 is transferred from a server 10 to a kiosk 20 via connections between the server 10 and the kiosk 20, based on patterns of access for that kiosk 20 that the server 10 has determined will make the most efficient use of the kiosk 20. At each scheduled push time, some content may be deleted from the kiosk 20 if it appears to be in less demand than other content and the storage available at the kiosk 20 is full; once content is downloaded to the kiosk 20, it is available for repeated, immediate perusal or purchase by end-users. If particular content is desired by an end-user but is not currently stored on the kiosk 20, the content can be retrieved from a server 10 in real-time; but the server 10 is able to calculate which content is the most likely to be requested at each kiosk 20 and to update the content at the kiosk 20 at the scheduled push time so that the most likely requests can be fulfilled without the need to download content in real-time.

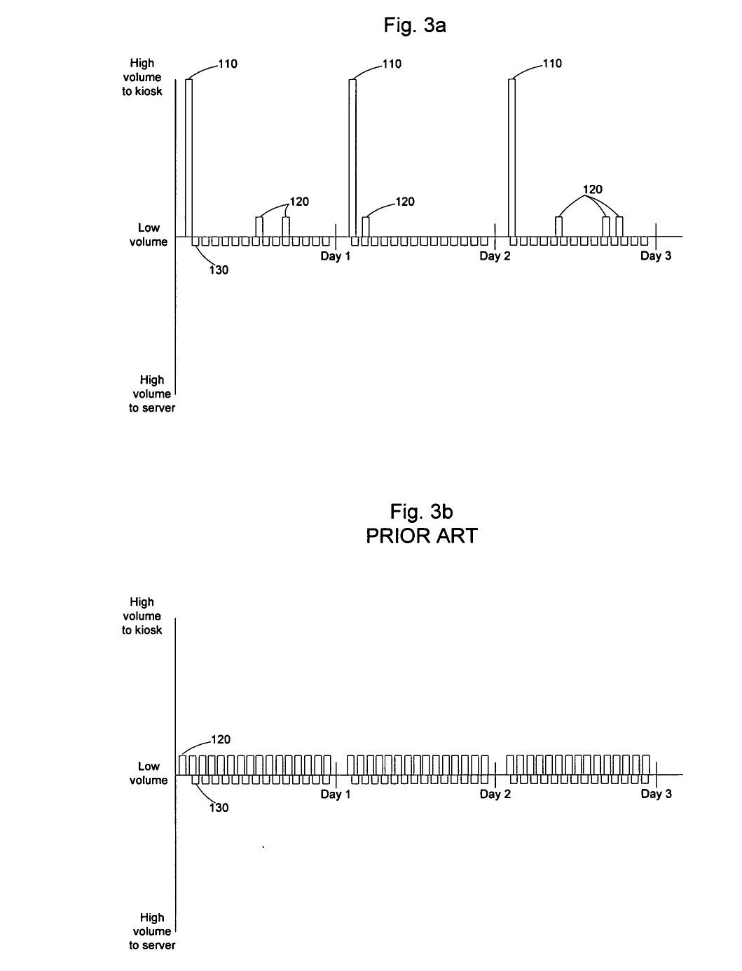

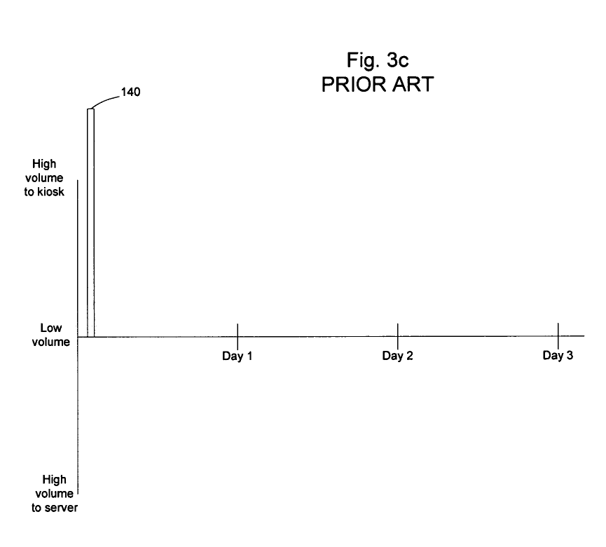

One example of a semi-dynamic transfer can be illustrated by the chart shown in FIG. 3a. In this chart, a large amount of data in the form of content is downloaded from server 10 to kiosk 20 at each scheduled push time 110. Most purchases by end-users are fulfilled using content downloaded at scheduled push time 110. If the desired content is not located on the kiosk 20, a real-time download 120 can occur, though these are infrequent when semi-dynamic content is used. Server data uploads 130 show that for each purchase transaction, purchase data and other data is uploaded to server 10, as described in this specification.

Semi-dynamic content may be contrasted with fully-dynamic content, as is known in the prior art, and as illustrated in FIG. 3b. When fully-dynamic content is used, the content available for purchase at a remote location is always transferred in real-time from another location. The real-time downloads 120 occur with every purchase transaction, resulting in often unacceptable delays for end-users, as well as inefficient use of network connectivity resources. Semi-dynamic content may also be contrasted with static content, as is known in the prior art, and as illustrated in FIG. 3c. When static content is used, a kiosk contains only a fixed set of content and cannot display or offer for sale any other content than what is currently stored at the kiosk. This is represented by the static download 140 in FIG. 3c. Static download 140 may occur via a network connection or via a manual data load using various data transfer mechanisms as are known in the art. FIG. 3c illustrates that, without any real-time downloads, no delays are introduced to dismay end-users; conversely, there is a necessarily limited set of content available.

When the content is transferred from the server to the kiosk, the operator of a server 10 may customize which content (or category, group of content, or advertising) is transferred semi-dynamically, as well as customize which content is transferred from a server 10 to a particular kiosk 20 (or to a collection of multiple kiosks 14). As non-limiting examples of the content selection parameters specified by a location partner 40, a location partner 40 that owned a venue catering to children may indicate that only music having no profanity in lyrics and only movies having a rating of G or PG are to be offered for sale; a location partner 40 may also indicate that only country music and only movies having either Clint Eastwood or John Wayne are to be offered for sale. An example of such parameters specified by a location partner 40 comprises a location partner 40 selling sports equipment may specify that advertising has a sports theme.

In some aspects, the method of using the system also includes the process of distributing the content to the end-user. As noted above, the second device of the system can be used to distribute the digital content to an end-user. For the system 5 illustrated in FIG. 1, the kiosk 20 can distribute the content to any desired user. The user can access the kiosk at any location where the kiosk is located. The kiosk 20 may be placed in any public (or private) location where members of the public will be drawn to it. A kiosk 20 owned or controlled by one entity may also be placed in a location designated by a location partner 40 that owns or controls the location of placement.

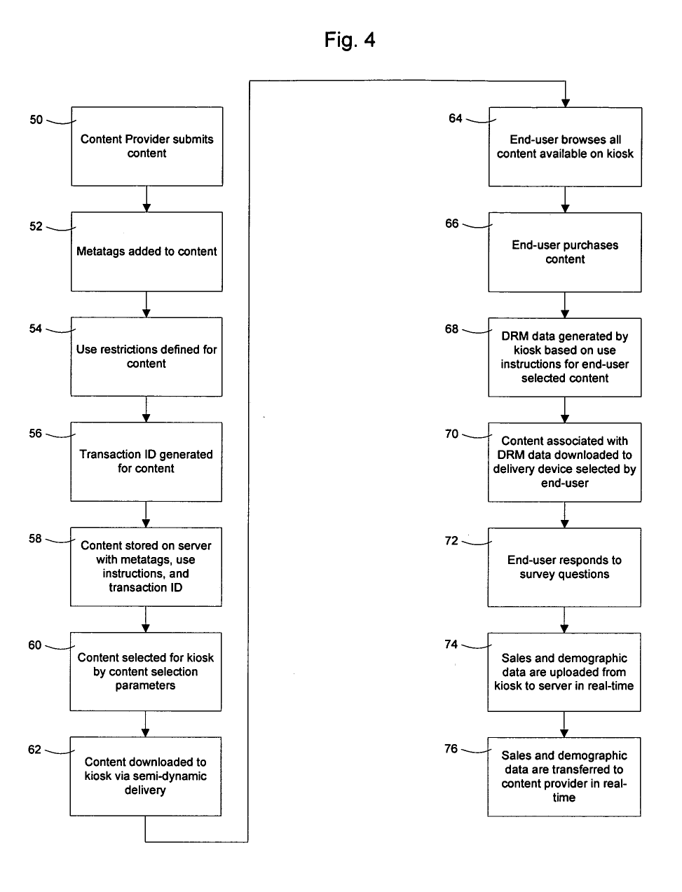

The user can interact with the kiosk 20 in any desired manner, whether or not content is actually distributed. Typically, the interaction proceeds in the following manner depicted in FIG. 4, although many variations are possible as to the steps followed by a particular user and the following steps need not be followed sequentially. At 64 in FIG. 4, the end-user can optionally view advertising on the first video screen and optionally begins to use an input device located on or adjacent to the kiosk to navigate among a collection of content that is available for review or sale via the kiosk. Next at 66, the user may optionally experience samples of content via the first or second video screen or another output device located on or adjacent to the kiosk. In one example, an end-user can listen to the first 30 seconds of a music file that is available for purchase via the kiosk. The end-user can then select content to be acquired, typically by paying a purchase price, and entering payment information as appropriate to the transaction, such as a credit card number or other account number through which a payment may be collected. This information can then be verified in real-time.

At 68 in FIG. 4, the method continues when DRM restrictions and license information are calculated as needed based on the use instructions associated with the content that was selected for purchase. The kiosk 20 can use multiple factors to generate customized DRM licensing information that is included in the content 16 that is transferred to the delivery device. Next, as shown at 70, the end-user can select a delivery device onto which the content 16 will be placed for use by the end-user and the content 16 is delivered to the selected delivery device using the semi-dynamic content system and including the calculated DRM information that is derived from a) the use instructions provided by the content provider that provided that content; b) default settings selected by the operator of the server; and c) the delivery device selected by the end-user.

After the requested content has been transferred to a delivery device controlled by the end-user, the end-user may use the content as he or she chooses, within the limits of the DRM restrictions that were part of the content transferred to the delivery device. As a non-limiting example, an end-user who purchased a digital music file and downloaded that file to a solid state storage device using a USB interface (the delivery device in this example) might be permitted to copy the music file three times, such as from the delivery device to a desktop computer, from the desktop computer to an audio CD, and from the desktop computer to a portable music player device. After these three copying operations, the music file could not be copied to any other device, though it could be played from any of the four devices on which it existed (the original delivery device, the desktop computer, the audio CD, and the portable music player device).

As depicted at 72 in FIG. 4, the end-user can then answer questions or in other ways reveals demographic, poll/voting, or personal data (“survey data”). This step is optionally completed while payment information is being authenticated, while content is being downloaded in real-time (if necessary based on the current state of the semi-dynamic content), and while content is transferred from the kiosk to the selected delivery device.

After the purchase at 74, the kiosk 20 may optionally print a receipt during or after a purchase. This receipt constitutes a transaction record and may optionally include coupons, discount codes, printed advertising material, or similar promotional items. Such promotional items may optionally be selected based upon the browsing activities of the end-user, upon items purchased, or upon related factors, analyzed singly or in combination.

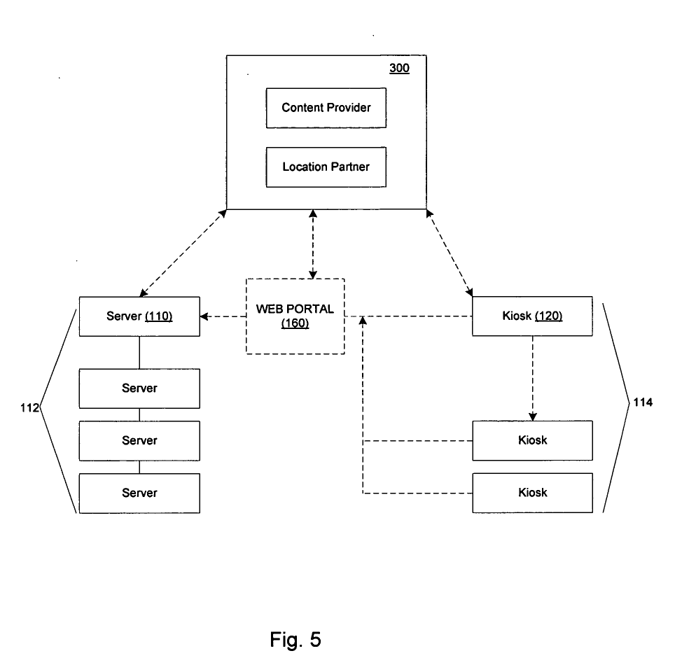

As well as transferring digital content to the remote device, the system can be used to transfer information from the remote device to the central device using any method, including the methods illustrated in FIG. 5. Any information can be transferred from the remote device (i.e., kiosk 120 or kiosk cluster 114) to the central device (i.e., server 110 or server cluster 112). One type of such information includes data about the performance of the system or any of its components, including the average wait times, the operating state of specific software, CPU usage, data transfer speeds, error/troubleshooting messages from software, utilities, drivers, and/or devices, security alarm information, inventory levels (i.e., refill supplies such as printer paper or blank audio CDs), back-up information, such as server, error, and product facilitation log lines

Another type of such information relates to the user and/or the user's activities at the remote device. One example of this information includes conversion data, such as pages viewed, images viewed, color schemes viewed, time of viewing, time of viewing in relation to purchase, content 16 or item(s) purchased/downloaded, requests made, demos/games played, registrations, signups, advertisements viewed, and so forth. Another example of this information includes user browsing activities, such as content viewed or selected, time spent viewing different content, and purchased content. Yet another example is demographic data, such as age, sex, ethnicity, race, marital status, household size, schooling/education, income, profession, languages spoken, citizenship, and the like. Even another example includes survey information, such as consumer satisfaction surveys, event expectation surveys, post-event evaluation surveys, polling/voting data. Another example includes user preference data, such as user selected color schemes, content preferences, advertisement preferences, e-mail preferences, and the like. Another example includes user-indicated items of interest, such as forms and genres of entertainment and hobbies. Another example includes user account information, such as username, password, address, phone number, e-mail address, unique login identifiers, cookies, user specific survey/conversion data, etc. . . . Another example includes biometric data such as fingerprints, voiceprints, hand geometries, retinal/iris scans, signature verifications, facial recognitions, video feed of end-user, pictures taken of end-user, audio recordings, and the like

Another type of such information relates to the demographic data at the location of the remote device, i.e., print/design advertising or products associated with remote device, kiosk location, seismic/meteorological activity, local advertisements, artist's music, local event calendaring, and so forth. Yet another type of information includes sales/transaction data such as the content sold, content price, royalty information, license numbers, inventory ID numbers, transactional IDs, time of sales, purchases contemplated or completed by the end-user, nature of delivery device, credit/debit/gift card information, promotional/discount codes, accounting information, and so forth.

Other information that may or may not fall within these categories can include purchase transaction data and survey data, the advertising content displayed immediately prior to and during the end-user's interaction with the kiosk; demographic data inherent in the location, design, or print advertising associated with the kiosk; demographic data collected from the end-user during the interaction; the nature of the delivery device selected by the end-user.

Of course, before any data can be transmitted to the central device, it must be collected and gathered at the remote device. Any device or apparatus that can collect and gather such data can be used. Examples of such devices include data gathering devices, including hand-held units, as well as the hardware and software components in the kiosk 120 mentioned above.

The collected data can then be transferred to the central device. The data can be transferred on a periodic basis, on a semi-dynamic basis, or on a real-time basis. Because perfect real-time basis may be available because of transmission speeds, the transfer can be on a near (or substantial) real-time basis. In other words, due to the delay caused by data transmission, processing, and analysis, real-time communications are often referred to in the art as near real-time, though they are often used interchangeably. In some aspects, the data is transferred as close to a real time basis as allowed under the operating conditions then existing because this allows for the immediate aggregation and dissemination of data from the central device.

The collected data may be communicated to content providers or other third parties 300 using a variety of techniques. In one technique, the entity controlling the server actively communicates to one or more content providers or other third parties using a means such as the following non-limiting examples: e-mail, EDI, DEX/UCS, or uploading of data to a separate computer controlled by the content provider or other third party. In a second technique, a content provider 300 or other third party is provided with access to the server 110 on which sales and demographic data is stored, or another server controlled by the same or an affiliated entity. This technique permits the content provider or other third party 300 to access sales and demographic data, including analyses and reports, in real-time or at times determined by the content provider or other third party 300. One example of a communication method by which a content provider or other third party 300 may access sales and demographic data on a server 110 is via a Web portal 160 provided by the entity that controls the server 110. This Web portal is provided in one exemplary embodiment by the same Web server that provides a Web page embodiment of a kiosk 20, with the server 10 providing appropriate information to content providers 30 and to end-users based on login location, authentication information provided, and other criteria as is standard in the art.

Other non-limiting examples of communication methods by which a content provider or a third party 300 may access or receive sales and demographic data are automatic facsimiles, phone calls, pages, instant messages sent by means such as Google Talk., Skype, or Windows Messenger, or reports delivered by the system when the content provider or third party calls. An example of a communication method where a content provider, system operator, or other third party can receive automatic reports is where the system phones a system operator to alert the operator of an inventory shortage. Another technique that allows content providers or third parties to access information is by allowing access to information directly from the kiosk. In this technique, a content provider or a third party accesses information by entering login location, authentication information provided, and other criteria as is standard in the art via a touchscreen or other input device, or by networking with the kiosk using a handheld connection machine such as a pocket-probe.

Once transferred to the central device, the data can then be reported to third parties 300. The types of third parties include the location partners, content providers or other third parties designated by content providers, including copyright owners. If content providers, copyright owners, or others are due royalties or other payments based on use or sale of content, such royalties or other payments may be made from the operator of a server to the appropriate recipient using automated means as are known in the art, based upon sales and demographic data. A system operator can also authorize any third party to receive reports and restrict the reports that the third party can access.

The data can be reported to the third parties by either transmitting it to the third parties or by allowing the third parties to access the central device either directly or indirectly through the web portal. In the former situation, the collected data may be optionally collated, analyzed, summarized, or otherwise processed using a variety of steps. This situation allows the operator of the system to perform the analysis, filter the results, and/or customize the report that is send to the third party. In the latter situation, the third party can view the collected data before (or as) it is received from the remote devices or anytime during the analysis, filtering, or customization process. Of course, access to the central device by the third party can be established using any parameters desired by the operator of the system, i.e., access to only certain portions of the collected data.

Alternatively, the collected data need not be transmitted to the central device before being reported to third parties. In these aspects of the systems, the data can be reported by either transmitting it to the third parties 300 from the remote device(s) (i.e., kiosk 120) or by allowing the third parties to access the remote device(s). Both of these situations give the third party more access to the raw data that has been collected, but does not allow the operator of the system to analyze, filter, or customize the report. Of course, access to the kiosk(s) by the third party can be established using any parameters desired by the operator of the system, i.e., access to only certain portions of the collected data.

In certain instances, the collected data can be sent to other kiosks. Such a situation can be advantageous when a location partner or third party wants to access data from a group of kiosks in the same location or vicinity. In these aspects of the systems, the data can be transmitting to-or-from the secondary remote device, allowing the third parties to access the data for both remote device(s). This situation gives the third party more access to the raw data that has been collected, but does not allow the viewer of the system to analyze, filter, or customize the report. Of course, access to the kiosk(s) by the third party can be established using any parameters desired by the operator of the system, i.e., access to only certain portions of the collected data.

In other instances, the collected data can be physically accessed by a third party 300 in the vicinity of the remote device. In such situations, the third party is often a location partner who accesses the collected data to analyze sales data. These configurations also allow the third party to be immediately alerted to the information gathered. For example, a third party at a remote location may operate a music store. After posting music from a featured artist, and a survey concerning event expectation for the artist's upcoming concert, the operator can check survey results in real-time in order to better plan for event attendance.

All of this information from the remote device(s) can be used for numerous purposes. In some aspects, the collected data can then be used to enhance and/or customize the operation of the system. Such a customization may be based upon factors such as statistics showing which content is most popular or most purchased at a given kiosk, survey data, customer browsing activity, customer profile, customer selected preferences, demographic data, price point of content, the requirements or requests of the owners of venues in which a kiosk is located (location partner 40 as shown in FIG. 1), or territorial requirements (such as state law regarding explicit content).

In other aspects of this transfer process, the collected data can be used to enhance the semi-dynamic transfer by the system. In these aspects, the server 10 can track what content and advertising messages are available at one or more kiosks 20 so as to enable the server 10 to efficiently determine what content or advertising messages to provide to each kiosk 20 during semi-dynamic data transfers, and also to permit the server 10 to report to other kiosks 20, to content providers 30, to location partners 40, or to other authorized third parties the locations of specific content or aggregate or statistical data derived therefrom.

In other aspects, the collected information can be part of the general and specific market research data that can be used by the operator of the system as known in the art. With the market research data, the operator of the system can access and immediately analyze customer, product and sales trends. As well, the market and research data can be used by the third parties to analyze product and consumer trends.

In yet other aspects, the collected information can be used to customize the content and/or the advertising provided to the user. For example, the collected data can be used to customize the content delivered in near real-time or used in the aggregate to predict the types/genre of media that is popular in a given locale. Alternatively, the collected data can be used to customize the digital content by day part, location, and audience.

In another example, the collected data can be used to customize the advertising. In this example, the customized advertising can be better targeted for viewer needs and desires and allow for advertising to broad general audiences or even niche markets and individual users. The advertising may include messages used to market, promote, or sell products or services or to enhance brand recognition, as well as training materials, entertainment content, community or location information, and other similar materials. In other aspects, the advertising may include video clips, audio clips, ring tones, printed coupons, promotional codes, brochures, literature, images, giveaways, discounts associated with digital content or other promotional or brand-related content. In some embodiments, advertising may be presented through video and/or audio presentations, animated PowerPoint presentations, flash programs, banners, pop-ups, screen-savers, wallpapers, posters, digital sampling, cost-per-pixel, cost-per-click, advertisement images, printed advertisements, trademarks and other similar advertisements. One example of the advertising includes the promotion of artists or performers, whose products or content are available for sale on the kiosk.

In some aspects, the advertising can be bundled with the content 16. In these aspects, the advertising is incorporated with or delivered along with the content 16 to the user in a digital or electronic format. One example of these aspects includes advertisements that are delivered with the content so that when a user accesses the content, the advertising is automatically displayed before or after the content. Another example includes advertisements that are delivered with the content so that the user can optionally choose to view the content when the content 16 is accessed.

In other aspects, the advertising is separate from the content 16. In these aspects, the advertising can still be delivered to the user, but is not incorporated (or bundled) with the content 16. In some aspects, the advertising is delivered in an electronic format. In other aspects, however, the advertising is delivered in any known physical format. One example of this advertising includes printing on surface of the media (i.e., CD or DVD) that is distributed to the user or using a printed adhesive label that can be attached to the surface of the media. Another example of this advertising includes printed materials that are delivered with—but are separate from—the media, including printed coupons (i.e., for a given retail location or specific manufacturer), promotions, gift certificates, samples, pamphlets, discount codes, watermarks, etc. . . . In some aspects, this advertising can be bundled or incorporated with any transaction receipt that is given to the user. In other aspects, the advertising can be bundled with the packaging for the media on which the digital content is stored. For example, advertisements on the back of photo paper, advertising on the back of storage containers for the media (i.e., jewel cases), advertising on the inserts for the storage containers, directly printing on the storage containers, and advertising with the product packaging (such as plastic wrappers for the storage containers or paper sleeves for the media).

Examples of the types of advertising include content-targeted advertisements (targeted to text, pictures, products, etc. . . . ), image specific ads (such as those described in U.S. Pat. No. 6,958,821, the disclosure of which is incorporated herein by reference), venue specific advertisements, random advertisements, affiliate advertising, demographic specific advertisements, banner advertisements, cost-per-click advertisements (i.e., such as those on Google Adsense/Adwords, Overture.com (Yahoo! Search Marketing), and Enhance.com), cost-per-pixel advertisements (i.e., such as those MillionDollarHomePage.com), wallpaper advertisements, screensaver advertisements, sampling advertisements (i.e., movie trailers), flash pictures and videos, framed videos, pictures, commercials, pop-up advertisements, point-of-purchase advertisements, free downloads, advertisements displays before allowing access to content or product lists, entertainment advertisements to keep the customer entertained when kiosk engages in semi-dynamic transfer to download content, and promotional and discount codes displayed on screen after the purchase.

In one variation on the systems and methods described above, an end-user can interact with a kiosk 20 to select and purchase content, but selects a delivery device that is not co-located with the kiosk 20 at which the original interaction and purchase occurred (the “delivery location”). As one example, an end-user could interact with a server using a Web page embodiment of a kiosk 20, then select a separate kiosk 20 having a CD-burning output device as the delivery location. As a second non-limiting example, an end-user could interact with a server 10 via a first kiosk 20 having two video displays and a CD burner, but then discover that the end-user's preferred delivery device, an audio CD, was unavailable because all blank audio CDs at that particular kiosk 20 have been used. In this scenario, the operator could be notified of the audio-CD shortage, in real-time, and send dispatch to replenish the kiosk's supplies. Meanwhile, the end-user could then select as the delivery location a kiosk 20 located in another building on the same campus where blank audio-CDs were available; or the end-user could select a Web page embodiment as the delivery location and a download to hard disk as the delivery device.

In another variation on the systems and methods described above, the entity that operates a server 10 or kiosk 20 may receive a fee or services in exchange for presenting a question as part of a survey conducted at a kiosk 20. In some aspects, such a question would be presented only to members of specific demographic groups as requested by the entity paying a fee or services to obtain responses to a question. The survey results could then be reviewed by the entity that operates a server 10 or kiosk or by a third party in real-time.

In yet another variation on the systems and methods described above, an end-user may establish a user account without using the kiosk 20, i.e., via a web page that is linked the system. Such a user account may require that an end-user pay a fee or may be offered without charge. Such a user account permits the end-user to receive marketing and promotional materials—including, as non-limiting examples, promotional codes, coupons, user specific advertisements determined by user preference settings or demographic data, and notices of forthcoming content and events related to content, such as concert dates, book signings, and so forth—via e-mail or other communications methods. Such a user account also permits a server 10 to track with more precision the activity of the end-user across multiple kiosks 20, browsing sessions, and purchase transactions. The data collected can then be relayed to a content provider 30 or a third party at a remote location in real-time.

By using this Web page technique, a content provider 30 may be enabled to encompass multiple activities related to exemplary embodiments through a single connection or interface. For example, a content provider 30 may use a Web page provided by the operator of a server 10 in order to complete any of the following activities: upload content to a server 10; indicate use instructions for content, either for specific pieces of content or by category or parameters describing multiple pieces of content; upload advertising content to a server 10; make recommendations to the operator of a server 10 as to preferred advertising content to be associated with content provided by that content provider 30; view or download sales data related to content provided by that content provider 30; view or download aggregate sales data or statistics related thereto for content provided by multiple content providers 30; view or download demographic data associated with purchase, viewing, or use of content provided by that content provider 30; view or download aggregated demographic data or statistics related thereto associated with purchase, viewing, or use of content provided by multiple content providers 30; configure preferences related to that content provider's upload, download, viewing, or other settings when interacting electronically with a server 10; and control or configure automatic provision of sales and demographic data or statistics related thereto to the content provider 30 via e-mail or communications methods known in the art.

In another variation on the systems and methods described above, a first device comprises a kiosk and a second device comprises a peripheral that may optionally be located remotely from that kiosk.

In still another variation on the systems and methods described above, multiple kiosks 14 may be linked in a manner such that purchases are completed on one or more kiosks 20 but the delivery location for all such purchases is a designated delivery device located on a specific kiosk 20. As one example, a retail establishment could maintain multiple kiosks 14 at which customers could browse available content. After purchase of content through any of those multiple kiosks 14, all end-users would collect an audio CD, DVD, video disk, or other delivery device from a separate kiosk 20 that was designed for high-volume generation of such delivery devices.

In addition to any previously indicated variation, numerous other modifications and alternative arrangements may be devised by those skilled in the art without departing from the spirit and scope of the invention and appended claims are intended to cover such modifications and arrangements. Thus, while the invention has been described above with particularity and detail in connection with what is presently deemed to be the most practical and preferred aspects of the invention, it will be apparent to those of ordinary skill in the art that numerous modifications, including but not limited to, form, function, manner of operation and use may be made without departing from the principles and concepts set forth herein.

We claim:

1. A method for real-time reporting, comprising:
providing a device for distributing digital content to a user, the device comprising means for semi-dynamically receiving digital content; and
providing means for reporting information about the use of the distribution device on a substantial real-time basis.

2. The method of claim 1, further comprising providing a device for storing the digital content.

3. The method of claim 1, wherein the distribution device and the storage device are located at separate locations.

4. The method of claim 1, further comprising means for semi-dynamically transferring the digital content from the storage device to the distribution device.

5. The method of claim 1, further comprising providing means for collecting information about use of the distribution device.

6. The method of claim 5, further comprising reporting the information to a third party.

7. The method of claim 6, further comprising first reporting the information to the storage device.

8. The method of claim 6, wherein the third party is an owner of the digital content or an owner of the location in which the distribution device is located

9. The method of claim 5, further comprising providing another distribution device and reporting the information from one distribution device to the other distribution device.

10. The method of claim 5, wherein the collecting means also collects information about a user of the distribution device.

11. A kiosk, comprising:
means for semi-dynamically receiving digital content;
means for distributing digital content to a user; and
means for reporting information about the use of the kiosk on a substantial real-time basis.

12. The kiosk of claim 11, further comprising means for collecting information about use of the distribution device.

13. The kiosk of claim 12, wherein the collecting means also collects information about a user of the kiosk.

14. The kiosk of claim 13, wherein the information comprises system performance, conversion data, browsing activities, demographic data, survey information, user preference data, user-indicated items of interest, user account information, biometric data, sales/transaction data, advertising data

15. A system for distributing digital content containing a kiosk, the kiosk comprising:
means for semi-dynamically receiving digital content;
means for distributing digital content to a user; and
means for reporting information about the use of the kiosk on a substantial real-time basis.

16. The system of claim 15, the kiosk further comprising means for collecting information about use of the distribution device.

17. A system for distributing digital content, comprising:
a device for distributing digital content to a user, the device comprising means for semi-dynamically receiving digital content; and
means for reporting information about the use of the distribution device on a substantial real-time basis.

18. The system of claim 17, further comprising means for collecting information about use of the distribution device.

19. The system of claim 18, further comprising a device for storing the digital content being located at a location different than the distribution device.

20. A method for distributing digital content, comprising:
providing a device for distributing digital content to a user, the device comprising means for semi-dynamically receiving digital content; and
operating that device while reporting information about the use of the distribution device on a substantial real-time basis.

21. The method of claim 20, further comprising collecting information about use of the distribution device.

22. The method of claim 20, further comprising reporting the information to a third party.

23. The method of claim 22, further comprising first reporting the information to the storage device.

24. The method of claim 22, wherein the third party is an owner of the digital content or an owner of the location in which the distribution device is located

25. The method of claim 21, further comprising providing another distribution device and reporting the information from one distribution device to the other distribution device.

26. The method of claim 21, wherein the collecting means also collects information about a user of the distribution device.

27. The method of claim 21, wherein the information comprises system performance, conversion data, browsing activities, demographic data, survey information, user preference data, user-indicated items of interest, user account information, biometric data, sales/transaction data, advertising data.
